(19) United States
(12) Patent Application Publication
(10) Pub. No.: US 2014/0067888 A1
(43) Pub. Date: Mar. 6, 2014

(54) COMMUNICATION DEVICE, INFORMATION PROVIDING DEVICE, AND WEB PAGE ACQUISITION PROGRAM

(71) Applicant: KABUSHIKI KAISHA TOSHIBA, Tokyo (JP)

(72) Inventors: Yuichiro Oyama, Tokyo (JP); Hiroshi Nishimoto, Kanagawa-ken (JP); Takeshi Ishihara, Kanagawa-ken (JP)

(73) Assignee: KABUSHIKI KAISHA TOSHIBA, Tokyo (JP)

(21) Appl. No.: 13/845,975

(22) Filed: Mar. 18, 2013

(30) Foreign Application Priority Data
Sep. 6, 2012 (JP) 2012-196448

(51) Int. Cl. G06F 17/30

(52) U.S. Cl. CPC G06F 17/30194
USPC 707/827

(57) ABSTRACT

A communication device has a request transmitter configured to transmit a batch acquisition request for an object to an information providing device providing a plurality of files needed to compose the object, a response generator configured to receive object information and files in the object information transmitted from the information providing device responding to the batch acquisition request, the object information including a file source information list of the respective files needed to compose the object and file sizes of the files, an area securing unit configured to allocate areas for storing the files in an information storage, based on the file sizes included in the received object information, and a storage controller configured to store the files received by the response generator in the areas in the information storage allocated by the area securing unit.

### CROSS REFERENCE TO RELATED APPLICATIONS

This application is based upon and claims the benefit of priority from the prior Japanese Patent Application No. 2012-196448, filed on Sep. 6, 2012, the entire contents of which are incorporated herein by reference.

### FIELD

Embodiments of the present invention relate to a communication device, an information providing device, and a Web page acquisition program, each being capable of acquiring a Web page.

### BACKGROUND

There has been known a communication system having a communication device which downloads and acquires various kinds of data from another communication node connected thereto through a network. For example, it is a widely known technique that the communication device accesses an HTML (Hyper Text Markup Language) file etc. provided on a Web server on the Internet through a browser application (hereinafter abbreviated to browser) using HTTP (Hypertext Transfer Protocol), to download content data from the Web server in accordance with the description of the accessed file.

The content data is, e.g., image data displayed on a screen. Generally, a single HTML file is used to request acquisition of a plurality of content data items. Accordingly, the browser transmits a content data request to the Web server on several occasions in accordance with the description of the HTML file, and content data is transmitted from the Web server on each occasion. Thus, the number of communication sessions between the communication device and the Web server is increased and much time is required to completely display the page corresponding to the HTML file, which leads to the increase in power consumption.

### BRIEF DESCRIPTION OF THE DRAWINGS

FIG. 1 is a diagram showing a schematic structure of a communication system 1 according to an embodiment.

FIG. 2 is a block diagram showing an example of the internal structure of a communication device 3.

FIG. 3 is a block diagram showing an example of the internal structure of an information providing device 4.

FIG. 4 is a sequence diagram showing an example of communication messages transmitted and received between the communication device 3 and the information providing device 4.

FIG. 5 is a diagram showing an example of page information fed back from the information providing device 4.

### DETAILED DESCRIPTION

According to one embodiment, a communication device has a request transmitter configured to transmit a batch acquisition request for an object to an information providing device providing a plurality of files needed to compose the object, a response generator configured to receive object information and files in the object information transmitted from the information providing device responding to the batch acquisition request, the object information including a file source information list of the respective files needed to compose the object and file sizes of the files, an area securing unit configured to allocate areas for storing the files in an information storage, based on the file sizes included in the received object information, and a storage controller configured to store the files received by the response generator in the areas in the information storage allocated by the area securing unit.

Embodiments will now be explained with reference to the accompanying drawings.

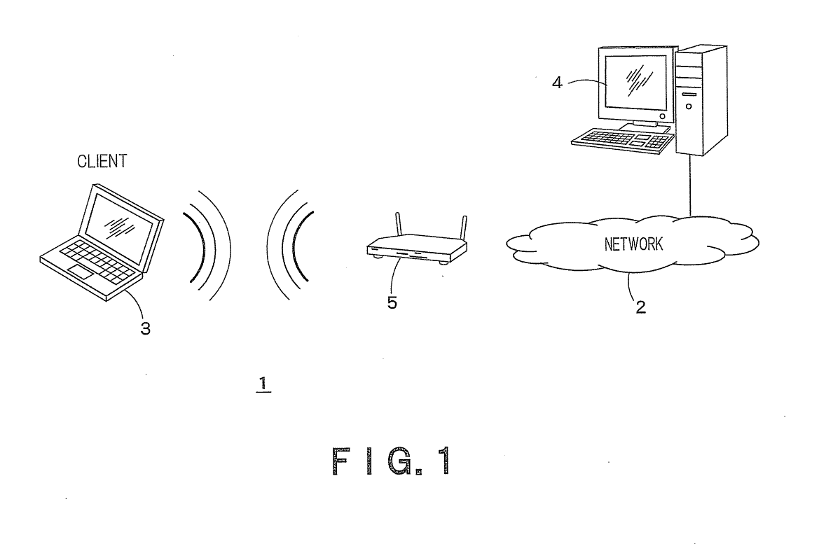

FIG. 1 is a diagram showing a schematic structure of a communication system 1 according to an embodiment. As shown in FIG. 1, the communication system 1 has a communication device 3 and an information providing device 4 communicating with each other through a network 2. The communication device 3 is, e.g., a client device of an end user, such as PC, tablet, smartphone, cellular phone, etc. The information providing device 4 is, e.g., a server device.

Although FIG. 1 shows one communication device 3 and one information providing device 4, there is no particular restriction on the number of communication devices 3 and information providing devices 4.

The network 2 may be a public network or a dedicated network, and may be wired or wireless. In FIG. 1, the communication device 3 and the information providing device 4 wirelessly communicate with each other through a wireless LAN access point 5 connected to the network 2, but this is only an example and wired communication may be performed instead.

In the example explained below, the network 2 is the Internet, the information providing device 4 is a Web server, and the communication device 3 is capable of displaying webpages on a Web browser.

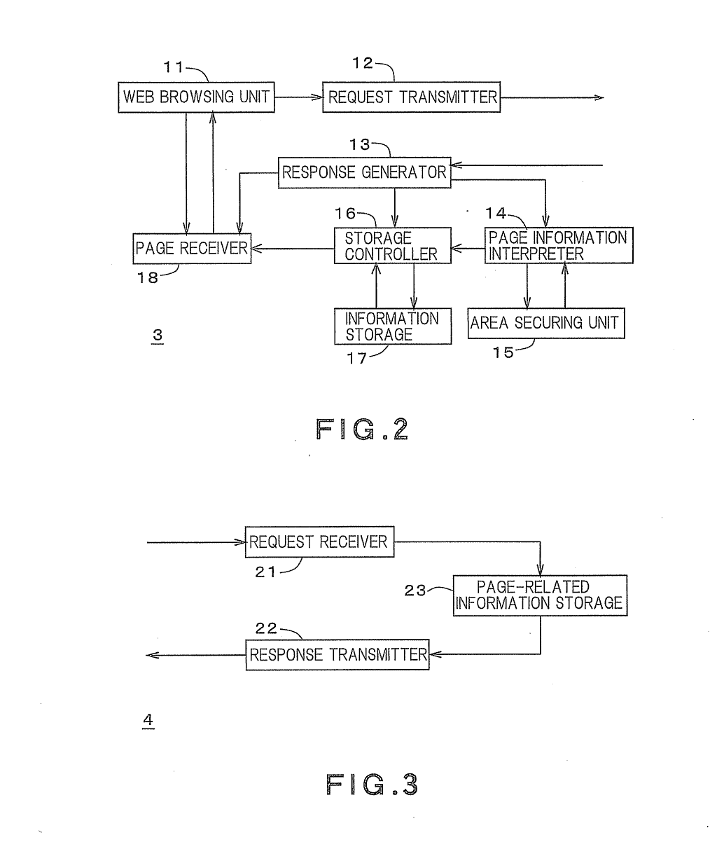

FIG. 2 is a block diagram showing an example of the internal structure of the communication device 3. The communication device 3 of FIG. 2 has a Web browsing unit 11, a request transmitter 12, a response generator 13, a page information interpreter 14, an area securing unit 15, an information storage 16, a storage controller 17, and a page receiver 18.

The Web browsing unit 11 performs control for starting a Web browser responding to the operation of a user so that a webpage is displayed on the Web browser on a screen of a client device.

The request transmitter 12 transmits a batch acquisition request for a webpage to the information providing device 4 providing a plurality of files needed to compose the webpage. A request different from the batch acquisition request for a webpage may be transmitted from the request transmitter 12 to the information providing device 4. The following explanation is premised on that the request transmitter 12 transmits a batch acquisition request to the information providing device 4.

The response generator 13 receives a response transmitted from the information providing device 4 responding to the request from the request transmitter 12, and transmits, to the page information interpreter 14, page information (object information) included in the response. More concretely, when the request transmitter 12 transmits a batch acquisition request for a webpage, the response generator 13 receives page information and files in the page information transmitted from the information providing device 4 responding to this request, the page information including a file source information list of the respective files needed to compose the webpage and file sizes of the files.

The page information interpreter 14 detects the file sizes of the files included in the webpage, based on the page information transmitted from the response generator 13.

The area securing unit 15 allocates storage areas in the information storage 16, in association with the file sizes detected by the page information interpreter 14. Then, the storage controller 17 stores the files received by the response generator 13 in the storage areas allocated by the area securing unit 15. The information storage 16 is, e.g., a main storage memory in the communication device 3.

The page receiver 18 detects reception situation of the files included in the webpage, and notifies the Web browsing unit 11 about the reception situation. More concretely, the page receiver 18 notifies the Web browsing unit 11 about the page information together with pointer information expressing storage locations of the received files.

FIG. 3 is a block diagram showing an example of the internal structure of the information providing device 4. The information providing device 4 of FIG. 3 has a request receiver 21, a response transmitter 22, and a page-related information storage 23.

The request receiver 21 receives the batch acquisition request for a webpage transmitted from the communication device 3. The request receiver 21 may receive a request different from the batch acquisition request for a webpage. The following explanation is premised on that the request receiver 21 receives a batch acquisition request.

Responding to the batch acquisition request from the communication device 3, the response transmitter 22 transmits page information including a file source information list of a plurality of files needed to compose the webpage and file sizes of the files, and transmits the files in the page information sequentially in a form capable of identifying correspondence between each of the files and each item in the file source information list.

The page-related information storage 23 stores the page information and at least a part of the files in this page information. The information providing device 4 does not necessarily retain all of the files needed to compose the webpage. Files retained by the information providing device 4 are stored in the page-related information storage 23, and locations of the other files not retained by the information providing device 4 are described in the file source information list.

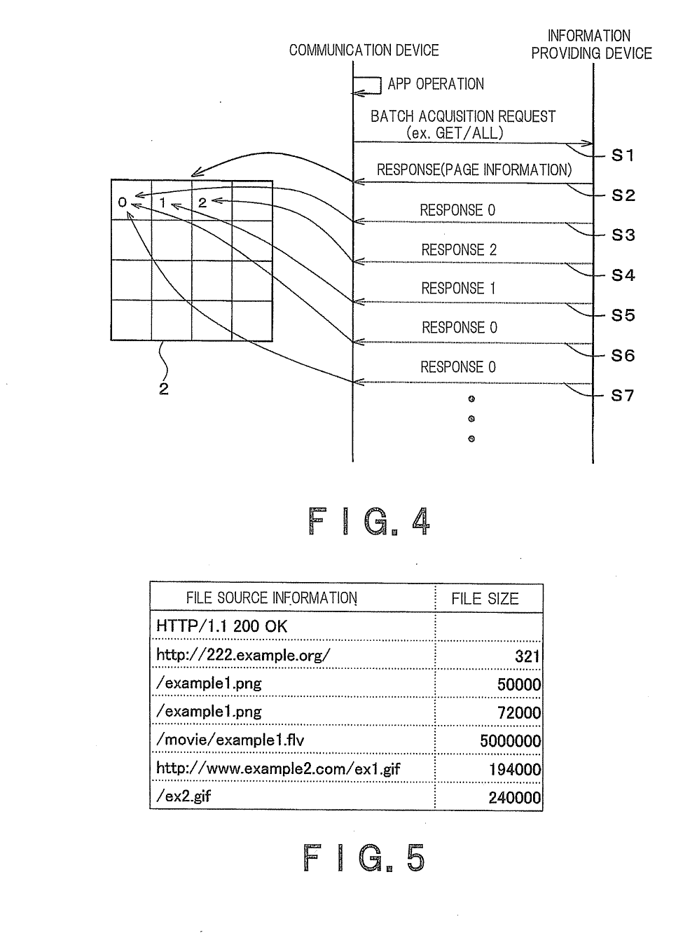

FIG. 4 is a sequence diagram showing an example of communication messages transmitted and received between the communication device 3 and the information providing device 4. This sequence diagram shows a communication procedure when the communication device 3, transmits a batch acquisition request for a webpage to the information providing device 4.

The communication device 3 transmits a batch acquisition request for a webpage to the information providing device 4, while executing a predetermined application (Step S1). In the example shown in FIG. 4, the batch acquisition request is transmitted using the description of “GET/ALL.” A concrete description for transmitting a batch acquisition request should not be limited to the description shown in FIG. 4. Further, the batch acquisition request may be specified using a new protocol, may be described in the path following an existing protocol, or may be described in the header of an HTTP message.

The information providing device 4 receives the batch acquisition request, and feeds back, to the communication device 3, page information including a source information list of a plurality of files needed to compose the requested webpage and file sizes of the files, together with the files in the page information (Steps S2 to S7).

The number of responses from the information providing device 4 differs depending on the number of files included in the webpage and on the file sizes of the files. In the example of FIG. 4, totally six responses are sent through Steps S2 to S7. In these responses, the response of Step S2 is used to transmit page information, and the responses of Steps S3 to S7 are used to transmit the respective files in the page information.

The area securing unit 15 in the communication device 3 receives the page information, and allocates areas in the information storage 16 to store the files therein, based on the file sizes included in the page information.

In the example shown in FIG. 4, three files are included in the page information, and the area securing unit 15 allocates three areas 0 to 2 in the information storage 16.

After that, the information providing device 4 transmits the files in the page information in several batches (Steps S2 to S7).

In the example of FIG. 4, file 0 is transmitted in three batches (Steps S3, S6, and S7), and each of files 1 and 2 is transmitted in one batch (Steps S5 and S4). File 0, file 1, and file 2 are stored in area 0, area 1, and area 2 of the information storage 16, respectively.

FIG. 5 is a diagram showing an example of page information fed back from the information providing device 4. In the example of FIG. 5, the page information includes a source information list recording file source information of the respective files for generating a webpage and file sizes of the files.

In the example of page information in FIG. 5, protocol to be used, version, and status code are described first, and then file source information of the respective files for generating a webpage and file sizes of the files are sequentially described while being related to each other. The file size may be described by total size of a plurality of files.

As shown in the example of FIG. 5, the file source information list describes file names for the files stored in the information providing device 4 itself, and describes URLs for the files to be acquired from other sites outside the information providing device 4. As stated above, the file sizes in the page information are used by the area securing unit 15 to allocate areas.

The page information of FIG. 5 includes only a file source information list and file size information, but another kind of information may be included. For example, the page information may include file IDs to identify the respective files for generating a webpage. If file IDs are included in the page information, files transmitted from the information providing device 4 to the communication device 3 in several batches can be easily identified by the communication device 3 using the file IDs and stored in previously allocated areas, even when the files are transmitted in random order.

For example, in FIG. 4, file 0 is transmitted in three batches. After transmitting a part of file 0, file 2 and file 1 are transmitted in this order, and then the remaining parts of file 0 are transmitted. In this way, when file IDs are included in page information, files can be transmitted in a different order from the list in the page information. The communication device 3 can correctly identify each file by checking each file ID included in the page information with the file ID of each file transmitted from the information providing device 4.

When file IDs are included in page information in this way, if, e.g., TCP is used for file transfer, a plurality of files multiplexed together can be transferred to one TCP connection. Alternatively, divided files of one file can be separately transferred through a plurality of connections.

When transmitting divided files, it is desirable to transmit the divided files in the order from the first to the last. Each file ID is identification information of each file and is not expected to provide information for identifying each of divided files for generating one file, and thus if divided files are transmitted in random order, it may be impossible for the communication device 3 to reassemble a file correctly.

Instead of specifically providing file IDs in page information, identification information may be automatically assigned to the respective files in the order of the file source information list in the page information.

For example, when assigning identification number 0 to the first file in the list and assigning sequential identification numbers to the subsequent files, there is no need to add the information category of file IDs to the page information, which leads to the reduction in data volume of the page information.

When transmitting the page information as shown in FIG. 5 from the information providing device 4 to the communication device 3, it may be stored in a single file, may be embedded in a specific HTML file (e.g., index.html), or may be included in the header of an HTTP message.

Note that the page information is not necessarily required to include a file source information list covering all of the files for generating a webpage, and only a part of the files may be included in the file source information list.

Further, the page information is not necessarily required to include file sizes of the respective files, and only the total file size of all files may be included in the page information. In this case, the area securing unit 15 allocates areas corresponding to the total file size to store each file in an arbitrary location in the allocated areas.

The information providing device 4 may transmit page information to the communication device 3 not only when responding to a batch acquisition request for a webpage transmitted from the communication device 3 but also when recognizing that an arbitrary file in the webpage has been changed, voluntarily.

In FIG. 4, some concrete techniques can be applied to Steps S1 and S2 for transmitting a batch acquisition request for a webpage from the communication device 3 to the information providing device 4 and for transmitting page information and files in the page information from the information providing device 4 to the communication device 3, responding to the request.

For example, when the communication device 3 transmits a batch acquisition request using a new protocol, the communication device 3 transmits such a message as below to the information providing device 4.

GET/HTTP/1.1

Host: example.com

Connection: Upgrade

Upgrade: Batch

The above message shows performing communication with the information providing device 4 utilizing HTTP protocol and requesting batch acquisition of a webpage “example.com” using Batch protocol in the communication. The webpage may be specified like this: “batch://example.com.”

The information providing device 4 receives this message and feeds back such a message as below to the communication device 3.

HTTP/1.1 101 Batch Protocol Handshake

Upgrade: Batch
Connection: Upgrade

The above message shows feeding back page information and files in the page information embedded in the header.

Alternatively, when the communication device 3 transmits a batch acquisition request using a path following an existing protocol, the communication device 3 transmits such a message as below to the information providing device 4.

GET/ALL HTTP/1.1

Host example.com

The information providing device 4 receives this message and feeds back such a header as below, page information, and files in the page information to the communication device 3.

HTTP/1.1 200 OK

In addition to the above examples, “UserAgent” header, “Host” header, “TE” header, “Accept” header, “Accept-encoding” header, etc. may be used to feed back page information etc. Further, another method such as “POST” method and “HEAD” method may be used in addition to “GET” method, to transmit a request.

As stated above, in the present embodiment, when the communication device 3 transmits a batch acquisition request for a webpage to the information providing device 4, the information providing device 4 feeds back, to the communication device 3, page information including a file source information list of the respective files for generating webpage and file sizes of the files together with the files in the page information. Then, the communication device 3 allocates areas in the information storage 16 based on the file sizes in the page information, and sequentially stores the received files in the allocated areas. In this way, a webpage can be acquired at high speed with a reduced number of communication sessions between the communication device 3 and the information providing device 4, and power consumption can be reduced while effectively using the information storage 16.

In the example explained in the above embodiments, batch acquisition of a webpage is achieved by performing communication between the communication device 3 and the information providing device 4, but a relay such as a proxy server device may be provided between the communication device 3 and the information providing device 4. This relay may function as the communication device 3 so that the relay transmits a batch acquisition request for a webpage to the information providing device 4. Alternatively, the relay may function as the information providing device 4 so that the relay receives and responds to the batch acquisition request from the communication device 3.

At least a part of the communication device 3 and information providing device 4 explained in the above embodiments may be formed of hardware or software. In the case of software, a program realizing at least a partial function of the communication device 3 and information providing device 4 may be stored in a recording medium such as a flexible disc, CD-ROM, etc. to be read and executed by a computer. The recording medium is not limited to a removable medium such as a magnetic disk, optical disk, etc., and may be a fixed-type recording medium such as a hard disk device, memory, etc.

Further, a program realizing at least a partial function of the communication device 3 and information providing device 4 can be distributed through a communication line (including radio communication) such as the Internet. Furthermore, this program may be encrypted, modulated, and compressed to be distributed through a wired line or a radio link such as the Internet or through a recording medium storing it therein.

In the above described embodiment, the example of performing a batch acquisition of the webpage has been described. However, an object of performing the batch acquisition is not limited to the webpage. The present embodiment is, for example, applicable even to the case of performing the batch acquisition of various kinds of objects such as E-mail.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A communication device comprising:
a request transmitter configured to transmit a batch acquisition request for an object to an information providing device providing a plurality of files needed to compose the object;
a response generator configured to receive object information and files in the object information transmitted from the information providing device responding to the batch acquisition request, the object information including a file source information list of the respective files needed to compose the object and file sizes of the files;
an area securing unit configured to allocate areas for storing the files in an information storage, based on the file sizes included in the received object information; and
a storage controller configured to store the files received by the response generator in the areas in the information storage allocated by the area securing unit.

2. The communication device of claim 1,
wherein the object information includes file identification information for identifying the respective files,
the area securing unit allocates the areas in association with the file identification information, and
the storage controller stores the files received by the response generator in the areas in association with the file identification information.

3. The communication device of claim 1, wherein the object is a webpage, further comprising:
a Web browsing unit configured to perform control for displaying the webpage on a display device; and
a page receiver configured to detect reception situation of the files included in the webpage, and to notify the Web browsing unit about the reception situation.

4. The communication device of claim 1,
wherein the request transmitter transmits the batch acquisition request by using a protocol dedicated to the batch acquisition request, path information of an existing protocol, or header information of the existing protocol.

5. The communication device of claim 1,
wherein the request transmitter transmits the batch acquisition request only once when HTTP is used as a protocol for communicating with the information providing device.

6. The communication device of claim 1,
wherein the response generator receives a file including the object information, or a message having the object information in its header or body, as a response message responding to the batch acquisition request.

7. The communication device of claim 1,
wherein the object information received by the response generator includes the file sizes of the respective files, or the total file size of all files.

8. An information providing device, comprising:
a request receiver configured to receive a batch acquisition request for an object transmitted from a communication device;
a response transmitter configured to transmit object information including a file source information list of a plurality of files needed to compose the object and file sizes of the files, and to transmit the files in the page information sequentially in a form capable of identifying correspondence between each of the plurality of files and each item in the file source information list, responding to the batch acquisition request; and
an object-related information storage configured to store the object information and at least a part of the files in this object information.

9. The information providing device of claim 8,
wherein the object information includes file identification information for identifying the respective files.

10. The information providing device of claim 8,
wherein the object information transmitted from the response transmitter includes the file source information list of all or a part of the files needed to compose the object.

11. The information providing device of claim 8,
wherein the request receiver receives the batch acquisition request by using a protocol dedicated to the batch acquisition request, path information of an existing protocol, or header information of an existing protocol.

12. The information providing device of claim 8,
wherein the request receiver receives the batch acquisition request only once when HTTP is used as a protocol for communicating with the communication device.

13. The information providing device of claim 8,
wherein the response transmitter transmits a file including the object information, or a message having the object information in its header or body, as a response.

14. The information providing device of claim 8,
wherein the response transmitter transmits the object information not only when responding to the batch acquisition request but also when recognizing that a file in the object has been changed.

15. A recording medium for storing a program executed by a computer,
the program comprising:
transmitting a batch acquisition request for an object from a communication device to an information providing device providing a plurality of files needed to compose the object;
receiving, by the communication device, object information and files in the object information transmitted from the information providing device responding to the batch acquisition request, the object information including a file source information list of the respective files needed to compose the object and file sizes of the files;
allocating, by the communication device, areas for storing the files in information storage, based on the file sizes included in the received object information; and
storing the files received by the communication device in the areas in the information storage allocated by the area securing unit.

16. The medium of claim 15,
wherein the object information includes file identification information for identifying the respective files,
the securing allocates the areas in association with the file identification information, and
the storing stores the received files in the areas in association with the file identification information.

17. The medium of claim 15, wherein the object is a webpage, further comprising:
performing, by a Web browsing unit, control for displaying the object on a display device; and
detecting reception situation of the files included in the object, and to notify the Web browsing unit about the reception situation.

18. The medium of claim 15,
wherein the transmitting transmits the batch acquisition request by using a protocol dedicated to the batch acquisition request, path information of an existing protocol, or header information of the existing protocol.

19. The medium of claim 15,
wherein the transmitting transmits the batch acquisition request only once when HTTP is used as a protocol for communicating with the information providing device.

20. The medium of claim 15,
wherein the receiving receives a file including the object information, or a message having the object information in its header or body, as a response message responding to the batch acquisition request.
